(19) United States
(12) Patent Application Publication
(10) Pub. No.: US 2009/0298991 A1
(43) Pub. Date: Dec. 3, 2009

(54) Thermoplastic Nanocomposite Resin Composition with Improved Scratch Resistance

(75) Inventors: Kee Hae KWON, Gunpo-si (KR); Il Jin KIM, Gunpo-si (KR); Hyung Rang MOON, Seoul (KR); Jae Bum PARK, Incheongwangyeok-si (KR); Seong Ho KONG, Seoul (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/479,000

(22) Filed: Jun. 5, 2009

Related U.S. Application Data
(63) Continuation-in-part of application No. PCT/KR2007/006996, filed on Dec. 28, 2007.

(30) Foreign Application Priority Data
Dec. 29, 2006 (KR) 2006-0138133

(51) Int. Cl. C08K 3/34; C08K 3/36

(52) U.S. Cl. 524/443; 524/442; 524/456; 524/444

(57) ABSTRACT

Disclosed herein is a thermoplastic nanocomposite resin composition comprising: (A) about 100 parts by weight of a thermoplastic resin; and (B) about 0.1 to about 50 parts by weight of metal (oxide) nanoparticles having surfaces that are organically modified with a silane compound. In the thermoplastic nanocomposite resin composition of the present invention, metal (oxide) nanoparticles are substantially uniformly dispersed into a thermoplastic resin matrix due to hybrid bonding between the resin matrix and the organo-surface modified metal (oxide) nanoparticles, so that the thermoplastic nanocomposite resin composition may provide considerably improved scratch resistance against surface damage to molded articles.

### CROSS-REFERENCE TO RELATED APPLICATIONS

This non-provisional application is a continuation-in-part application of PCT Application No. PCT/KR2007/006996, filed Dec. 28, 2007, pending, which designates the U.S. and which is hereby incorporated by reference in its entirety, and claims priority therefrom under 35 USC Section 120. This application also claims priority under 35 USC Section 119 from Korean Patent Application No. 10-2006-0138133, filed Dec. 29, 2006, the entire disclosure of which is also hereby incorporated by reference.

### FIELD OF THE INVENTION

The present invention relates to a thermoplastic nanocomposite resin composition.

### BACKGROUND OF THE INVENTION

In general, although thermoplastic resins can have a low specific gravity and excellent physical properties including moldability and impact resistance as compared with glass or metal, thermoplastic resins can also exhibit relatively poor surface scratch resistance.

Acrylonitrile-butadiene-styrene terpolymer resin is widely used in various articles such as housings for electrical and electronic appliances, interior and exterior materials for automobiles, and office equipment since the acrylonitrile-butadiene-styrene terpolymer resin can have excellent impact resistance, chemical resistance and formability and superior mechanical properties. However, the butadiene-based rubber used to improve impact resistance of the resin can also substantially lower scratch resistance of the resin. As a result, molded articles formed of such resins can easily be scratched during transportation or use thereof, which can damage the external appearance of the articles.

In order to overcome these problems, a hard coating method has been widely used to improve scratch resistance of a resin surface by doping a surface of a finally molded resin with an organic-inorganic hybrid material and then curing the organic-inorganic hybrid material using heat or ultraviolet radiation. However, the hard coating method has disadvantages such as long process times, increased costs and environmental problems resulting from the required additional coating process.

Therefore, as a result of such environmental and cost problems, demand for non-coated resins capable of exhibiting scratch resistance without a hard coating has increased. Further, industries using resins to form exterior materials require resins with excellent scratch resistance.

### SUMMARY OF THE INVENTION

To solve the foregoing problems, the present inventors have developed a thermoplastic resin composition having improved scratch resistance while maintaining the inherent physical properties of the thermoplastic resin. According to the present invention, there is provided a thermoplastic nanocomposite resin composition comprising (A) about 100 parts by weight of a thermoplastic resin and (B) about 0.1 to about 50 parts by weight of metal (oxide) nanoparticles having surfaces that are organically modified using a silane compound.

The organic surface modified metal (oxide) nanoparticles (B) can be prepared by a sol-gel reaction of metal (oxide) nanoparticles and a silane compound.

In another embodiment of the present invention, the metal (oxide) nanoparticles can have an average particle diameter ranging from about 1 to about 300 nm and are a colloidal form.

In one embodiment of the present invention, the thermoplastic nanocomposite resin composition comprises about 100 parts by weight of a thermoplastic resin including a mixture of about 15 to about 80 parts by weight of a rubber modified graft copolymer (g-ABS) and about 20 to about 85 parts by weight of a styrene-acrylonitrile (SAN) copolymer, and about 0.1 to about 50 parts by weight of metal (oxide) nanoparticles having surfaces that are organically modified using a silane compound.

In one embodiment of the present invention, the thermoplastic nanocomposite resin composition has a flexural modulus of about 24,000 kgf/cm² or more for a specimen with a thickness of ¼″ according to ASTM D790, and a scratch profile having a scratch width of about 335 μm or less, a scratch depth of about 15 μm or less, a scratch range of about 21 μm or less and a scratch area of about 4450 μm² or less measured on a specimen for hardness measurement with dimensions of 50 mm length×40 mm width×3 mm thickness according to a ball-type scratch profile test using a spherical metal tip with a load of 1000 g, a scratch speed of 75 mm/min, and a diameter of 0.7 mm.

In an embodiment of the present invention, the metal (oxide) nanoparticles (B) with surfaces that are organically modified using a silane compound are substantially uniformly dispersed in a matrix of the thermoplastic resin (A).

Further, the present invention provides pellets obtained by extruding the thermoplastic nanocomposite resin composition, and articles produced using the thermoplastic nanocomposite resin composition, such as electrical and electronic appliances and interior and exterior materials for automobiles obtained by molding the pellets.

Furthermore, the present invention provides a method of preparing a thermoplastic nanocomposite resin composition. The method comprises the steps of: preparing organic surface modified metal (oxide) nanoparticles (B) through a sol-gel reaction by adding about 0.1 to about 60% by weight of a silane compound (b2) into about 40 to about 99.9% by weight of colloidal metal (oxide) nanoparticles (b1) with a pH of about 1 to about 4; and extruding the organic surface modified metal (oxide) nanoparticles (B) together with a thermoplastic resin (A).

The present invention accordingly provides a thermoplastic nanocomposite resin composition with improved scratch resistance without deterioration in inherent physical properties of the resin such as formability, impact resistance and heat resistance. The present invention further provides a thermoplastic nanocomposite resin composition in which the content of inorganic filler can be reduced as compared to conventional dispersions of inorganic filler. As a result, the thermoplastic nanocomposite resin composition can have reduced specific gravity.

In addition, the metal (oxide) nanoparticles can be substantially uniformly dispersed in the thermoplastic resin matrix using only extrusion. Although not wishing to be bound by any explanation of the invention, it is currently believed that nanoparticles are substantially uniformly dispersed into a thermoplastic resin matrix during an extrusion/injection molding process through hybrid bonding (physical and chemical adsorption) of the organic surface modified colloidal metal (oxide) nanoparticles and the thermoplastic resin. This in turn is believed to contribute to the improved scratch resistance and protection against surface damage exhibited by molded articles produced using the thermoplastic nanocomposite resin composition of the invention.

The resultant thermoplastic nanocomposite resin composition accordingly can be useful for the production of products requiring scratch resistance, such as electrical and electronic appliances, interior and exterior materials for automobiles, and office equipment.

### DESCRIPTION OF DRAWINGS

FIG. 1 (a) is a transmission electron microscope (TEM) photograph of a nanocomposite resin prepared in Example 3, and FIG. 1 (b) is a TEM photograph of a nanocomposite resin prepared in Comparative Example 3.

FIG. 2 is a diagram determining a standard of scratch resistance from a measured scratch profile.

FIG. 3 (a) is a scratch profile of a nanocomposite resin prepared in Example 4, and FIG. 3 (b) is a scratch profile of a nanocomposite resin prepared in Comparative Example 4.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

(A) Thermoplastic Resin

A thermoplastic resin (A) of the present invention is used as a matrix resin, and the thermoplastic resin is not particularly limited.

Examples of the thermoplastic resin may include without limitation polycarbonate (PC), polyolefin, polyvinyl chloride (PVC), polyphenylene ether (PPE), polyphenylene sulfide (PPS), polyester, polyamide, (meth)acrylate copolymer, aromatic vinyl compound (co)polymer resin, rubber modified aromatic vinyl graft copolymer resin, and aromatic vinyl-vinyl cyanide copolymer resin. The thermoplastic resin may be used alone, or as a combination of at least two or more thermoplastic resins.

Exemplary aromatic vinyl compounds may include without limitation styrene, α-methyl styrene, β-methyl styrene, o-, m- or p-methyl styrene, o-, m- or p-ethyl styrene, o-, m- or p-t-butyl styrene, o-, m- or p-chloro styrene, dichloro styrene, o-, m- or p-bromo styrene, dibromo styrene, vinyl toluene, vinyl xylene, vinyl naphthalene, and divinyl benzene. The aromatic vinyl compound may be used alone, or as a combination of at least two or more aromatic vinyl compounds.

Exemplary vinyl cyanide based compounds may include without limitation acrylonitrile, methacrylonitrile, ethacrylonitrile, or a combination thereof.

Exemplary rubbers may include without limitation diene-based rubbers such as butadiene rubber, butadiene-styrene copolymer and poly(acrylonitrile-butadiene), saturated rubbers prepared by adding hydrogen into the diene-based rubbers, isoprene rubber, acryl-based rubber, ethylene-based rubber, and ethylene-propylene-diene monomer (EPDM) terpolymer. The rubber may be used alone, or as a combination of at least two or more rubbers.

Exemplary (meth)acrylates may include without limitation methyl methacrylate, ethyl methacrylate, propyl methacrylate, butyl methacrylate, phenyl methacrylate, benzyl methacrylate, methyl acrylate, ethyl acrylate, propyl acrylate, butyl acrylate, and 2-ethylhexyl acrylate. The (meth)acrylate may be used alone, or as a combination of at least two or more (meth)acrylates.

Exemplary thermoplastic resins useful in the present invention may include without limitation polystyrene (PS), acrylonitrile-butadiene-styrene copolymer resin (ABS resin), rubber-modified polystyrene (HIPS: high impact polystyrene) resin, acrylonitrile-styrene-acrylate copolymer resin (ASA resin), styrene-acrylonitrile copolymer resin (SAN resin), methyl methacrylate-butadiene-styrene copolymer resin (MBS resin), acrylonitrile-ethyl acrylate-styrene copolymer resin (AES resin), polyphenylene ether (PPE), polyphenylene sulfide (PPS), polycarbonate resin (PC resin), polyethylene (PE), polypropylene (PP), polyethylene terephthalate (PET), polybutylene terephthalate (PBT), polyvinyl chloride (PVC), polymethyl methacrylate (PMMA), and combinations thereof.

(B) Organic Surface Modified Metal (Oxide) Nanoparticles

Organic surface modified metal (oxide) nanoparticles (B) can be prepared by a sol-gel reaction of metal (oxide) nanoparticles (b1) with a silane compound (b2).

The organic surface modified metal (oxide) nanoparticles may be prepared by allowing about 40 to about 99.9% by weight, for example about 70 to about 99% by weight, and as another example about 75 to about 95% by weight of colloidal metal (oxide) nanoparticles (b1) to sol-gel react with about 0.1 to about 60% by weight, for example about 1 to about 30% by weight, and as another example about 5 to about 25% by weight of an alkoxy silane compound (b2). As used herein, in the present invention, the term “colloidal metal (oxide) nanoparticle” refers to a “colloidal metal oxide nanoparticle,” a “colloidal metal nanoparticle,” and combinations thereof.

Examples of the metal (oxide) nanoparticles (b1) may include metal oxides such as silicon dioxide (SiO₂), aluminum oxide (Al₂O₃), titanium dioxide (TiO₂), tin dioxide (SnO₂), ferric oxide (Fe₂O₃), zinc oxide (ZnO), magnesium oxide (MgO), zirconium dioxide (ZrO₂), cerium dioxide (CeO₂), lithium oxide (Li₂O), silver oxide (AgO) and antimony oxide (Sb₂O₃), and metals such as silver (Ag), nickel (Ni), magnesium (Mg) and zinc (Zn). The metal (oxide) nanoparticles may be used alone, or as a combination of at least two or more metal (oxide) nanoparticles.

The metal (oxide) nanoparticles (b1) of the present invention may have an average particle diameter ranging from about 1 to about 300 nm, for example about 5 to about 100 nm.

The metal (oxide) nanoparticles (b1) may be spheres and may be in a colloidal state.

The metal (oxide) nanoparticles (b1) may be in a state where the particles are not substantially agglomerated, for example, non-agglomerated particles. Agglomeration of the particles can deteriorate dispersibility of the particles in a resin matrix and lower scratch resistance.

Colloidal metal nanoparticles with a basic property (pH of 8 to 12) or an acidic property (pH of 1 to 4), which are stabilized by adjusting the amount of counter ions with metal salts or metal ions can be used as the metal (oxide) nanoparticles (b1) of the present invention. In exemplary embodiments, the colloidal metal nanoparticles have a pH range of about 1 to about 4.

The silane compound (b2) provides organic functional groups on the surfaces of colloidal metal nanoparticles and thus provides hydrophobicity to the colloidal metal nanoparticles and enhances dispersibility of the nanoparticles in a resin composition.

The silane compound (b2) may have hydrolysable silane residues and one or more of organic residues in addition to the silane residues, and may include one or more components selected from acryloxyalkyl trimethoxysilane, methacryloxyalkyl trimethoxysilane, methacryloxyalkyl triethoxysilane, vinyl trimethoxysilane, vinyl triethoxysilane, methyl trimethoxysilane, methyl triethoxysilane, propyl trimethoxysilane, perfluoroalkyl trialkoxysilane, perfluoromethyl alkyl trialkoxysilane, glycidoxyalkyl trimethoxysilane, aminopropyl trimethoxysilane, aminopropyl triethoxysilane, aminoethyl aminopropyl triethoxysilane, mercaptopropyl trimethoxysilane, mercaptopropyl triethoxysilane, mercaptopropyl methyldiethoxysilane, mercaptopropyl dimethoxymethylsilane, mercaptopropyl methoxydimethylsilane, mercaptopropyl triphenoxysilane, mercaptopropyl tributoxysilane, and the like, and combinations thereof.

In one embodiment, condensates and a solvent phase dispersion thereof can be prepared by the organic surface modification process, in which about 40 to about 99.9% by weight of the metal nanoparticles (b1) and about 0.1 to about 60% by weight of the silane compound (b2) with respect to about 100 parts by weight of a solvent are mixed at room temperature, and a condensation reaction of the mixture is performed at a temperature of about 40 to about 80° C. The solvent can include at least one of water and alcohols having 1 to 4 carbon atoms. The condensation reaction can be carried out for about 1 to about 6 hours.

The organic surface modified metal (oxide) nanoparticles (B) may be prepared in the form of powder particles through dehydration and drying. The organic surface modified metal (oxide) nanoparticles (B) can be in a state where the nanoparticles are not substantially agglomerated. This is because agglomeration of the nanoparticles deteriorates dispersibility of the nanoparticles in a resin matrix to result in lowering of scratch resistance.

Preparation of a Nanocomposite Resin Composition

A nanocomposite resin composition can be prepared through a process of kneading and extruding the organic surface modified metal (oxide) nanoparticles (B) and the thermoplastic resin (A). Functional groups on surfaces of the organic surface modified metal nanoparticles are physically and chemically bonded with a matrix resin during the extrusion process, so that a resin composition with improved scratch resistance can be prepared.

One embodiment of the present invention comprises the steps of: preparing organic surface modified metal (oxide) nanoparticles (B) through a sol-gel reaction by adding about 0.1 to about 60% by weight of a silane compound (b2) into about 40 to about 99.9% by weight of colloidal metal (oxide) nanoparticles (b1) with a pH of about 1 to about 4; and extruding the organic surface modified metal (oxide) nanoparticles (B) together with a thermoplastic resin (A).

In the present invention, a surface of a colloidal metal oxide is organically modified through a sol-gel reaction (condensation reaction by hydrolysis), thereby enhancing the compatibility of the colloidal metal oxide with a thermoplastic resin. Therefore, a nanocomposite structure is formed so that the organic surface modified metal (oxide) nanoparticles (B) are substantially uniformly dispersed in a matrix of the thermoplastic resin (A), and the nanocomposite structure can be confirmed by electron microscopes such as a TEM (transmission electron microscope) and an SEM (scanning electron microscope).

In one embodiment of the present invention, pellets may be manufactured by extruding about 0.1 to about 50 parts by weight of the organic surface modified metal (oxide) nanoparticles and about 100 parts by weight of a thermoplastic resin including a mixture of about 15 to about 80 parts by weight of a rubber modified graft copolymer (g-ABS) and about 20 to about 85 parts by weight of a styrene-acrylonitrile (SAN) copolymer at a temperature of about 200 to about 270° C. The rubber modified graft copolymer (g-ABS) is a graft copolymer which is prepared by graft polymerizing about 25 to about 70 parts by weight of a rubber polymer, about 40 to about 90 parts by weight of an aromatic vinyl compound, and about 10 to about 60 parts by weight of a vinyl cyanide based monomer, and the styrene-acrylonitrile (SAN) copolymer is a copolymer which is prepared by graft polymerizing about 40 to about 90 parts by weight of an aromatic vinyl compound and about 10 to about 60 parts by weight of an acrylonitrile-based monomer. In one embodiment of the present invention, the thermoplastic nanocomposite resin composition has a flexural modulus of about 24,000 kgf/cm² or more for a specimen with a thickness of ¼″ according to ASTM D790, and a scratch profile having a scratch width about 335 μm or less, a scratch depth of about 15 μm or less, a scratch range of about 21 μm or less and a scratch area of about 4450 μm² or less measured on a specimen for hardness measurement with dimensions of 50 mm length×40 mm width×3 mm thickness according to a ball-type scratch profile test using a spherical metal tip with a load of 1000 g, a scratch speed of 75 mm/min, and a diameter of 0.7 mm.

In another embodiment of the present invention, pellets can be manufactured by extruding about 100 parts by weight of a rubber-modified polystyrene (HIPS) resin and about 0.1 to about 50 parts by weight of the organic surface modified metal (oxide) nanoparticles at a temperature of about 200 to about 270° C. When the rubber-modified polystyrene resin (HIPS) is used as the matrix resin, it is possible to confirm its morphology, in which the nanoparticles are substantially uniformly dispersed at a nano level throughout the resin matrix, using a TEM, and the nanoparticles impart excellent scratch resistance.

In a further embodiment of the present invention, pellets can be manufactured by extruding about 100 parts by weight of a polycarbonate (PC) resin with a weight average molecular weight (M_{w}) of about 10,000 to about 200,000 and about 0.1 to about 50 parts by weight of organic surface modified metal (oxide) nanoparticles at a temperature of about 200 to about 270° C. When the polycarbonate resin is used as the matrix resin, it is possible to confirm its morphology, in which the nanoparticles are substantially uniformly dispersed at a nano level throughout the resin matrix, using a TEM, and the nanoparticles impart improved scratch resistance.

In a still further embodiment of the present invention, pellets can be manufactured by extruding about 100 parts by weight of an acrylonitrile-styrene-acrylate copolymer resin (ASA resin) and about 0.1 to about 50 parts by weight of the organic surface modified metal (oxide) nanoparticles at a temperature of about 200 to about 270° C. When the acrylonitrile-styrene-acrylate copolymer resin is used as the matrix resin, it is possible to confirm its morphology, in which the nanoparticles are substantially uniformly dispersed at a nano level throughout the resin matrix, using a TEM, and the nanoparticles impart improved scratch resistance

In a still further embodiment of the present invention, pellets can be manufactured by extruding about 100 parts by weight of polypropylene (PP) and about 0.1 to about 50 parts by weight of the organic surface modified metal (oxide) nanoparticles at a temperature of about 200 to about 270° C. When the polypropylene is used as the matrix resin, it is possible to confirm its morphology, in which the nanoparticles are substantially uniformly dispersed at a nano level throughout the resin matrix, using a TEM, and the nanoparticles impart improved scratch resistance.

In a still further embodiment of the present invention, pellets can be manufactured by extruding a methyl methacrylate-butadiene-styrene (MBS) copolymer resin and about 0.1 to about 50 parts by weight of the organic surface modified metal (oxide) nanoparticles at a temperature of about 200 to about 270° C. When the methyl methacrylate-butadiene-styrene copolymer resin is used as the matrix resin, it is possible to confirm its morphology, in which the nanoparticles are substantially uniformly dispersed at a nano level throughout the resin matrix, using a TEM, and the nanoparticles impart improved scratch resistance.

A thermoplastic nanocomposite resin composition according to the present invention can obtain excellent physical properties using a small quantity of a filler having a size smaller than that of a conventional filler by enhancing the dispersibility of the nanoparticles by hybrid bonding between the resin matrix and the organic surface modified nanoparticles through surface modification of nanoparticles. Therefore, the content of inorganic filler can be reduced to decrease the specific gravity of the composite, so that improved effects of mechanical properties and scratch resistance can be obtained while maintaining formability of a thermoplastic resin by introducing the organic functional groups onto surfaces of the nanoparticles.

In the present invention, a thermoplastic composite resin for extrusion and injection molding is prepared by optionally adding additives as necessary into the thermoplastic composite resin. Exemplary additives include without limitation surfactants, nucleating agents, coupling agents, fillers, plasticizers, impact modifiers, admixing agents, colorants, stabilizers, lubricants, antistatic agents, pigments, flame retardants, and the like, and combinations thereof.

A thermoplastic nanocomposite resin composition of the present invention can be used in products requiring scratch resistance, such as electrical and electronic appliances, interior and exterior materials for automobiles and office equipment, since the thermoplastic nanocomposite resin composition allows dispersion of the nanoparticles at a nano level, thereby reducing the content of an inorganic filler as compared to a conventional dispersion, and has very excellent scratch resistance while maintaining the formability of a thermoplastic resin.

In one embodiment of the present invention, the thermoplastic nanocomposite resin composition is molded for use in housings of electrical and electronic appliances such as television sets, audio sets, washing machines, cassette players, MP3 players, telephones, video consoles, computers, printers, and the like.

In another embodiment of the present invention, the thermoplastic nanocomposite resin composition is molded for use as interior and exterior materials for automobiles such as automobile dashboards, instrument panels, door panels, quarter panels, and wheel covers.

The foregoing molding method includes extrusion, injection and casting, but is not limited thereto. The molding method may be easily performed by those skilled in the art to which the present invention pertains.

The present invention will be more understood by the following examples. However, the following examples are only for illustrative purposes of the present invention and do not intend to limit the scope of the present invention defined by the appended claims.

### EXAMPLES

Specifications of respective components used in Examples and Comparative Examples as follows.

(A) Thermoplastic Resin

A resin prepared by blending 25 parts by weight of a graft copolymer (g-ABS) prepared by graft polymerizing 50% by weight of polybutadiene, 35% by weight of styrene and 15% by weight of acrylonitrile and 75 parts by weight of a copolymer (SAN) with a weight average molecular weight of 125,000 prepared by copolymerizing 71.5% by weight of styrene and 28.5% of acrylonitrile is used.

(B) Organic Surface Modified Metal (Oxide) Nanoparticles

Organic surface modified metal (oxide) nanoparticles prepared by adding 13% by weight of aminopropyl trimethoxysilane into 87% by weight of a colloidal silica sol having a nanoparticle surface area of 150 m²/g and a pH of 1 to 4 and organically modifying the surfaces of particles through a sol-gel reaction are used.

(C) Fumed Silica

Fumed silica with a nanoparticle surface area of 135+25 m²/g, which is Aerosil 130 produced by Deggusa Corporation, is used.

### Examples 1-4

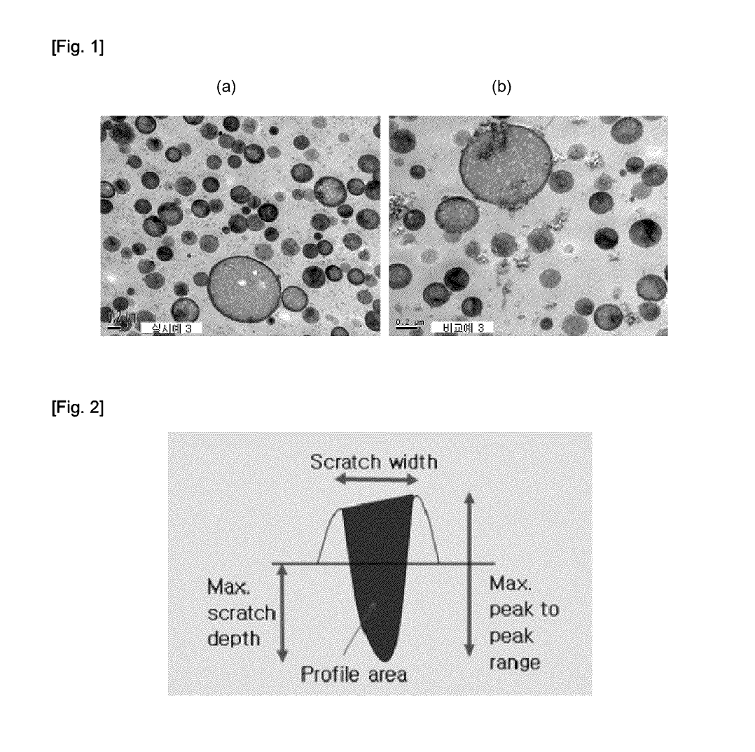

The components as shown in Table 1 are mixed and the mixture is melted and extruded through a twin screw extruder with L/D=29 and Φ=45 mm in pellets. The pellets are dried at 80° C. for 6 hours. The dried pellets are molded into test specimens using a 6 oz injection molding machine. The transmission electron micrograph (TEM) of a thermoplastic nanocomposite resin obtained in Example 3 is shown in FIG. 1(a). FIG. 1(a) confirms the morphology of the composition, in which the nanoparticles are substantially uniformly dispersed at a nano level throughout the resin matrix.

### Comparative Examples 1-5

Comparative Examples 1-4 are prepared by the same method as in the foregoing Examples except that non-surface modified fumed silica instead of the organic surface modified metal (oxide) nanoparticles is used. The morphology of a thermoplastic nanocomposite resin prepared in Comparative Example 3 is confirmed by a transmission electron microscope (TEM) photograph, which is shown in FIG. 1 (b). As illustrated in FIG. 1 (b), it can be observed that agglomeration is generated in a resin matrix when the non-surface modified fumed silica is used. A specimen is prepared only using a thermoplastic resin in Comparative Example 5.

Evaluation of Scratch Resistance

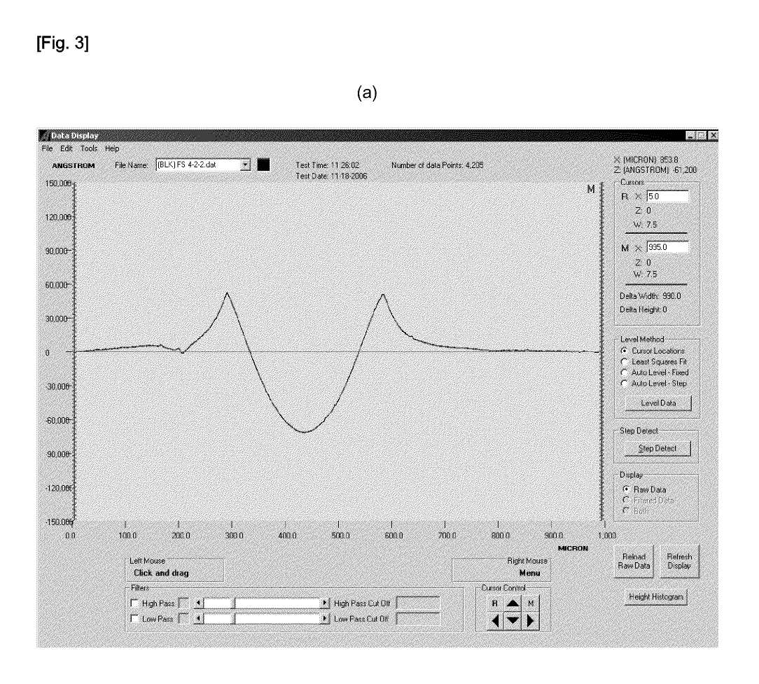

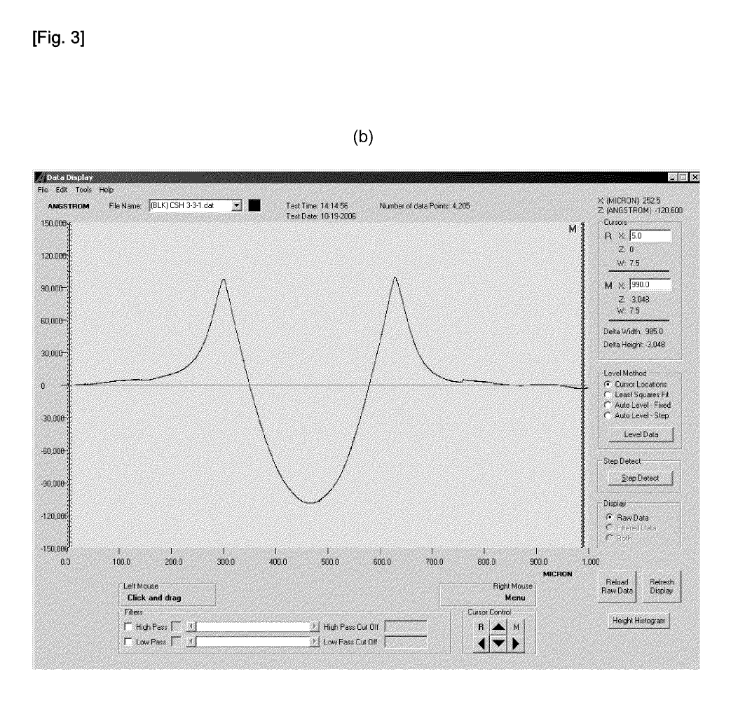

Scratch resistance is measured by a ball-type scratch profile (BSP) test. The BSP test is a method for evaluating scratch resistance from scratch width, scratch depth, scratch range and scratch area that are indexes of scratch resistance by measuring a profile of the applied scratch through a surface profile analyzer after applying a scratch of a length of 10 to 20 mm onto a resin surface at predetermined load and speed. Any one of a contact type surface profile analyzer and a non-contact type surface profile analyzer can be used as the surface profile analyzer to measure the scratch profile. The contact type surface profile analyzer provides a scratch profile through surface scanning using a metal stylus tip with a diameter of 1 to 2 μm, and the non-contact type surface profile analyzer includes a three-dimensional microscope and an optical analyzer such as an AFM. In the present invention, a contact type surface profile analyzer (XP-1) of Ambios Corporation is used, and a metal stylus tip with a diameter of 2 μm is used. The scratch width, scratch depth, scratch range and scratch area as indexes of scratch resistance are determined from the measured scratch profile according to a diagram disclosed in FIG. 2. At this time, as the measured scratch width, scratch depth, scratch range and scratch area are decreased, the scratch resistance is increased. A unit of the width, scratch depth and scratch range is μm, and a unit of the scratch area is μm². When measuring scratch, the applied load is 1,000 g, a scratch speed is 75 mm/min, and a metal spherical tip with a diameter of 0.7 mm is used to generate scratches. Specimens for hardness measurement with dimensions of length of 50 mm×width of 40 mm×thickness of 3 mm are used to measure scratch resistance. FIG. 3 (a) illustrates a photograph showing a scratch profile photograph measured from Example 4, and FIG. 3 (b) illustrates a photograph showing a scratch profile measured from Comparative Example 4. Referring to FIG. 2, the scratch width, scratch depth, scratch range and scratch area are measured from the photographs showing scratch profiles of the Examples and Comparative Examples, and the measurement results are represented in the following Table 1.

Evaluation of Flexural Modulus

Flexural modulus is measured on specimens prepared from the compositions of Examples and Comparative Examples according to ASTM D790, and the measurement results are represented in the following Table 1, wherein a specimen thickness is ¼″, and a unit of the flexural modulus is Kgf/cm².

TABLE 1

| | | Examples | | | | Comparative Examples | | | | |
|---|---|---|---|---|---|---|---|---|---|---|
| Classification | | 1 | 2 | 3 | 4 | 1 | 2 | 3 | 4 | 5 |
| (A) | | 100 | 100 | 100 | 100 | 100 | 100 | 100 | 100 | 100 |
| (B) | | 5 | 10 | 20 | 30 | — | — | — | — | — |
| (C) | | — | — | — | — | 5 | 10 | 20 | 30 | — |
| Flexural Modulus | | 24,780 | 25,960 | 27,000 | 28,570 | 23,950 | 24,390 | 24,900 | 24,810 | 23,390 |
| BSP test | Width (μm) | 330 | 315 | 299 | 289 | 338 | 335 | 341 | 347 | 340 |
| | Depth (μm) | 14.7 | 13.2 | 10.9 | 9.2 | 15.8 | 15.1 | 16.1 | 16.8 | 16.0 |
| | Range | 20.2 | 18.7 | 16.3 | 12.0 | 23.0 | 22.4 | 23.2 | 24.1 | 23.0 |
| | (μm) | | | | | | | | | |
| | Area (μm²) | 4,419 | 3,890 | 2,955 | 2,160 | 4,950 | 4,720 | 5,095 | 5,610 | 5,030 |

As shown in Table 1, it can be seen that although Examples 1 to 4 and Comparative Examples 1 to 4 show improved scratch resistance as compared with Example 5 which did not include inorganic nanoparticles, the resin compositions of the present invention of Examples 1 to 4 show improved scratch resistance as compared to the resin compositions of Comparative Examples 1 to 4 when the same content of inorganic nanoparticles is contained. This is because the dispersibility of the nanoparticles is enhanced by hybrid bonding between the resin matrix and the organic surface modified nanoparticles through the surface treatment of the nanoparticles, and thus superior physical properties can be obtained using a small amount of a filler having a size smaller than a conventional inorganic filler. Furthermore, it can be observed that agglomeration is generated in a resin matrix in case of Comparative Example 3 in which a non-surface modified fumed silica is used as illustrated in FIG. 1 (b). However, it can be confirmed that the nanoparticles are well dispersed into the resin matrix in case of Example 3 in which the organic surface modified silica is used. That is, it can be confirmed that scratch resistance is considerably improved with flexural modulus maintained when using the metal oxide nanoparticles having surfaces that are organically modified using the silane compound of the present invention.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic nanocomposite resin composition with improved scratch resistance comprising:
(A) about 100 parts by weight of a thermoplastic resin; and
(B) about 0.1 to about 50 parts by weight of metal (oxide) nanoparticles comprising surfaces that are organically modified with a silane compound.

2. The thermoplastic nanocomposite resin composition of claim 1, wherein said thermoplastic resin is polycarbonate (PC), polyolefin, polyvinyl chloride (PVC), polyphenylene ether (PPE), polyphenylene sulfide (PPS), polyester, polyamide, (meth)acrylate copolymer, aromatic vinyl(co)polymer resin, rubber modified aromatic vinyl graft copolymer resin, aromatic vinyl-vinyl cyanide copolymer resin or a combination thereof.

3. The thermoplastic nanocomposite resin composition of claim 1, wherein said metal (oxide) nanoparticles comprising organically modified surfaces are prepared by a sol-gel reaction of metal (oxide) nanoparticles and a silane compound.

4. The thermoplastic nanocomposite resin composition of claim 3, wherein said metal (oxide) nanoparticles comprising organically modified surfaces are prepared by a sol-gel reaction of about 40 to about 99.9% by weight of the metal (oxide) nanoparticles and about 0.1 to about 60% by weight of a silane compound.

5. The thermoplastic nanocomposite resin composition of claim 3, wherein said metal (oxide) nanoparticles comprise at least one metal oxide selected from silicon dioxide (SiO₂), aluminum oxide (Al₂O₃), titanium dioxide (TiO₂), tin dioxide (SnO₂), ferric oxide (Fe₂O₃), zinc oxide (ZnO), magnesium oxide (MgO), zirconium dioxide (ZrO₂), cerium dioxide (CeO₂), lithium oxide (Li₂O), silver oxide (AgO) or antimony oxide (Sb₂O₃); at least one metal selected from silver (Ag), nickel (Ni), magnesium (Mg) or zinc (Zn); or a combination thereof.

6. The thermoplastic nanocomposite resin composition of claim 3, wherein said metal (oxide) nanoparticles have an average particle diameter ranging from about 1 to about 300 nm and are a colloidal form.

7. The thermoplastic nanocomposite resin composition of claim 3, wherein said silane compound comprises at least one selected from acryloxyalkyl trimethoxysilane, methacryloxyalkyl trimethoxysilane, methacryloxyalkyl triethoxysilane, vinyl trimethoxysilane, vinyl triethoxysilane, methyl trimethoxysilane, methyl triethoxysilane, propyl trimethoxysilane, perfluoroalkyl trialkoxysilane, perfluoromethyl alkyl trialkoxysilane, glycidoxyalkyl trimethoxysilane, aminopropyl trimethoxysilane, aminopropyl triethoxysilane, aminoethyl aminopropyl triethoxysilane, mercaptopropyl trimethoxysilane, mercaptopropyl triethoxysilane, mercaptopropyl methyldiethoxysilane, mercaptopropyl dimethoxymethylsilane, mercaptopropyl methoxydimethylsilane, mercaptopropyl triphenoxysilane, mercaptopropyl tributoxysilane or a combination thereof.

8. The thermoplastic nanocomposite resin composition of claim 1, wherein said thermoplastic nanocomposite resin composition comprises about 100 parts by weight of a thermoplastic resin comprising a mixture of about 15 to about 80 parts by weight of a rubber modified graft copolymer (g-ABS) and about 20 to about 85 parts by weight of a styrene-acrylonitrile (SAN) copolymer; and about 0.1 to about 50 parts by weight of metal (oxide) nanoparticles comprising surfaces that are organically modified with a silane compound.

9. The thermoplastic nanocomposite resin composition of claim 8, wherein said thermoplastic nanocomposite resin composition has a flexural modulus of about 24,000 kgf/cm² or more for a specimen with a thickness of ¼″ according to ASTM D790, and a scratch profile having a scratch width of about 335 μm or less, a scratch depth of about 15 μm or less, a scratch range of about 21 μm or less and a scratch area of about 4450 μm² or less measured on a specimen for hardness measurement with dimensions of 50 mm length×40 mm width×3 mm thickness according to a ball-type scratch profile test using a spherical metal tip with a load of 1000 g, a scratch speed of 75 mm/min, and a diameter of 0.7 mm.

10. The thermoplastic nanocomposite resin composition of claim 1, wherein said metal (oxide) nanoparticles (B) comprising surfaces that are organically modified using a silane compound are substantially uniformly dispersed in a matrix of the thermoplastic resin (A).

11. The thermoplastic nanocomposite resin composition of claim 1, further comprising an additive selected from surfactants, nucleating agents, coupling agents, fillers, plasticizers, impact modifiers, admixing agents, colorants, stabilizers, lubricants, antistatic agents, pigments, flame retardants, or a combination thereof.

12. A molded article produced from the thermoplastic nanocomposite resin composition as defined in claim 1.

13. A method of preparing a thermoplastic nanocomposite resin composition comprising:
preparing organic surface modified metal (oxide) nanoparticles (B) through a sol-gel reaction by adding about 0.1 to about 60% by weight of a silane compound (b2) into about 40 to about 99.9% by weight of colloidal metal (oxide) nanoparticles (b1) with a pH of about 1 to about 4; and
extruding the organic surface modified metal (oxide) nanoparticles (B) together with a thermoplastic resin (A).
